(19) United States
(12) Patent Application Publication
(10) Pub. No.: US 2021/0251372 A1
(43) Pub. Date: Aug. 19, 2021

(54) MULTIFUNCTIONAL WATER CUP SLEEVE

(71) Applicant: COMTEL ENTERPRISE CO., LTD., Tainan (TW)

(72) Inventor: Chung-Cheng CHU, Tainan (TW)

(21) Appl. No.: 17/015,120

(22) Filed: Sep. 9, 2020

(30) Foreign Application Priority Data
Feb. 17, 2020 (TW) 109201754
Mar. 6, 2020 (TW) 109202577
Mar. 20, 2020 (TW) 109203267

(51) Int. Cl. A45F 5/02

(52) U.S. Cl. CPC A45F 5/021; B62J 11/04; A45F 2200/0583

(57) ABSTRACT

The invention provides a multifunctional water cup sleeve, which mainly comprises a fastener and a water cup. The front of the fastener provided with a slideway and a locking component, on which a button enables users to control the locking component, the back of said fastener provided with a fastening clip. The water cup provided with a protruding ring on one side for fastening, it features protruding ring including a neck portion and a locking slot. As such, the fastener can fasten the water cup to a user's waistband.

### BACKGROUND OF THE INVENTION

### 1. Field of the Invention

This invention relates to a multifunctional water cup sleeve, in particular which a cup sleeve that users can carry around and use easily while exercising.

### 2. Description of the Prior Art

Sports are now a rising trend, with activities such as marathon and hiking gaining popularity. Generally, marathon organizers will set up refreshment stands at a certain distance to provide drinks, which involves using a huge number of paper cups, resulting in environmental problems such as wasted resources and the disposal of paper cups. In light of these problems, some organizers offer participants cups that they can hold in their hands while running and to consume drinks at refreshment stands. However, it is relatively inconvenient for participants to hold a cup as they run, hampering the implementation of the waste reduction policy: “one cup all the way.”

### SUMMARY OF THE INVENTION

The objective of this invention is provide people with a multifunctional water cup sleeve that is easy to carry and use while exercising.

The main characteristics of the invention is provides a kind of multifunctional water cup sleeve, includes a fastener and a water cup, the features on its front provided with a slideway and a locking component, above which is a button that controls the fastening or ejection of the locking slot, on the back of the fastener provided with a fastening clip and a u-shaped spring metal plate, and a water cup, which is attached to the fastener and has a protruding ring for fixation on one side.

### BRIEF DESCRIPTION OF DRAWINGS

This invention will be understood by referring to the accompanying drawings, wherein:

FIG. 1 is an exploded perspective view illustrating the first example of a fastener and a water cup in the present invention;

FIG. 2 is a perspective view illustrating the first example of a fastener and a water cup in the present invention;

FIG. 3 is an illustration showing the first example of the present invention when it is fastened to the waistband of a user;

FIG. 4 is an exploded perspective view illustrating the second example of a fastener, a cup holder and a water cup in the present invention;

FIG. 5 is a perspective view illustrating the second example of a fastener and a cup holder in the present invention;

FIG. 6 is an illustration showing the second example of a water cup placed in the cup holder;

FIG. 7 is an illustration showing the second example of the present invention in which the button on the fastener is pressed downward and the cup holder is pulled upward from the slideway;

FIG. 8 is an illustration demonstrating the second example of the present invention of the fastener is attached to a waistband;

FIG. 9 is an illustration showing the second example of the present invention when it is attached to the handle of a bicycle; and

FIG. 10 is an illustration portraying the second example of another design of the cup holder.

### DETAILED DESCRIPTION OF THE PREFERRED EMBODIMENT

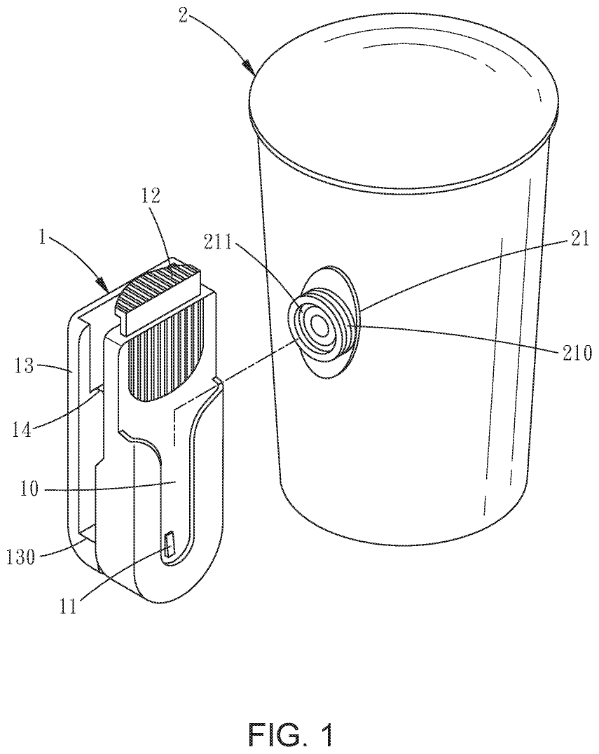

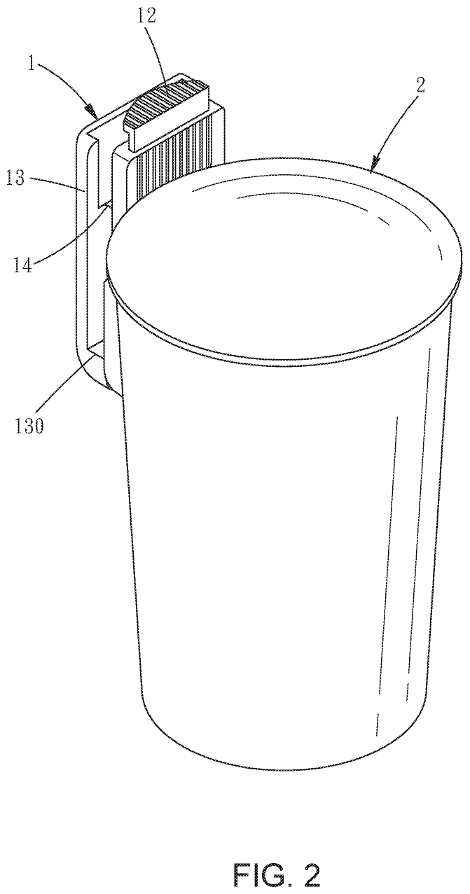

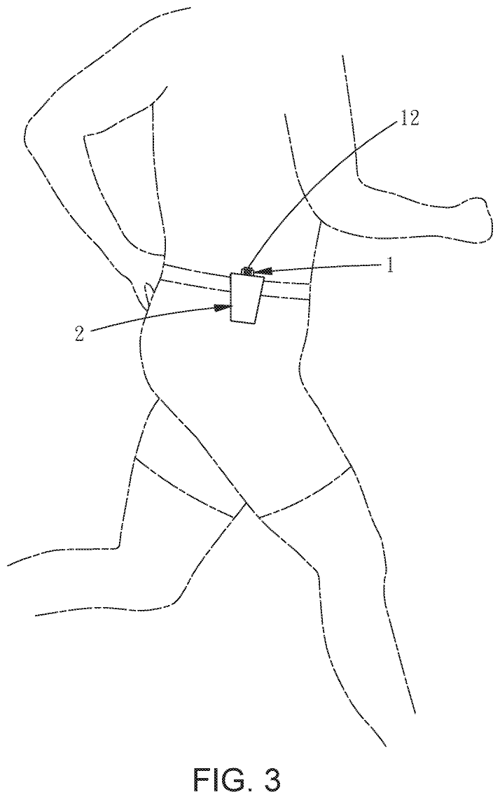

As shown in FIGS. 1 to 3, The first example of the present invention mainly consists of a fastener 1 and a water cup 2. The fastener 1 features on its front a slideway 10 and a locking component 11, above which is a button 12 that controls the fastening or ejection of the locking component 11. On the back of the fastener 1 are a fastening clip 13 and a u-shaped spring metal plate 14; the fastening clip 13 has a block holder 130 on its end. The water cup 2, combined with the fastener 1, has a protruding ring 21, which features a neck portion 210 and a locking slot 211. The neck portion 210 is slightly narrower than the slideway 10, so it can fit into the slideway 10 on the fastener 1 and slide on it.

In using, to fasten the water cup 2, the fastening clip 13 of the fastener 1 is attached to a waistband, the neck portion 210 on the protruding ring 21 is then fit into the slideway 10 on the fastener 1 and slid down until the protruding ring 21 reaches the bottom of the slideway 10, where the locking slot 211 of the protruding ring 21 receives the locking component 11. To use the water cup 2 for water, the button 12 on the fastener 1 is pressed down to eject the locking component 11 from the locking slot 211 of the water cup 2, the protruding ring 21 will slide out from the slideway 10, allowing the water cup 2 to be taken out easily. To refasten the water cup 2, fit the neck portion 210 of the protruding ring 21 on the water cup 2 into the slideway 10 on the fastener 1 and slide it downward to meet the locking component 11.

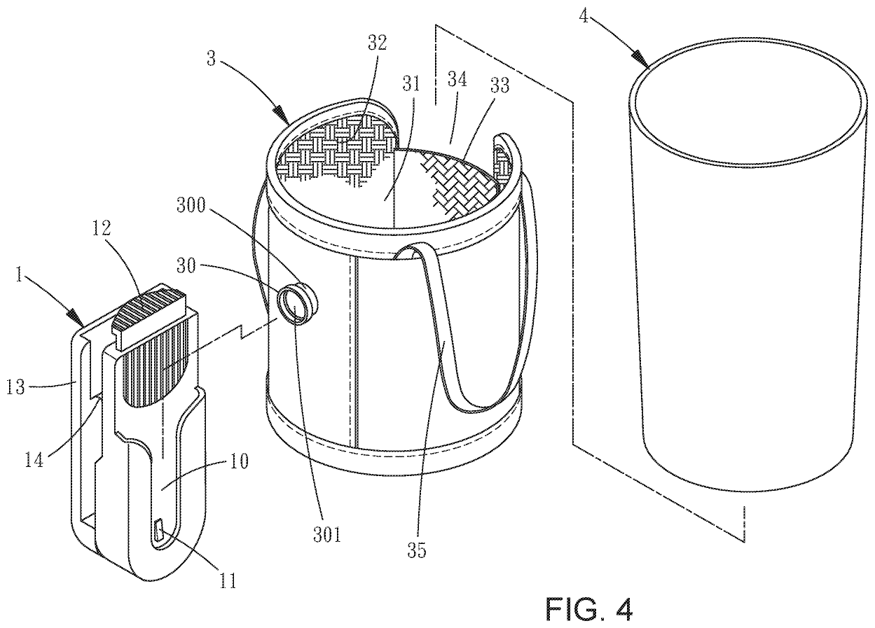

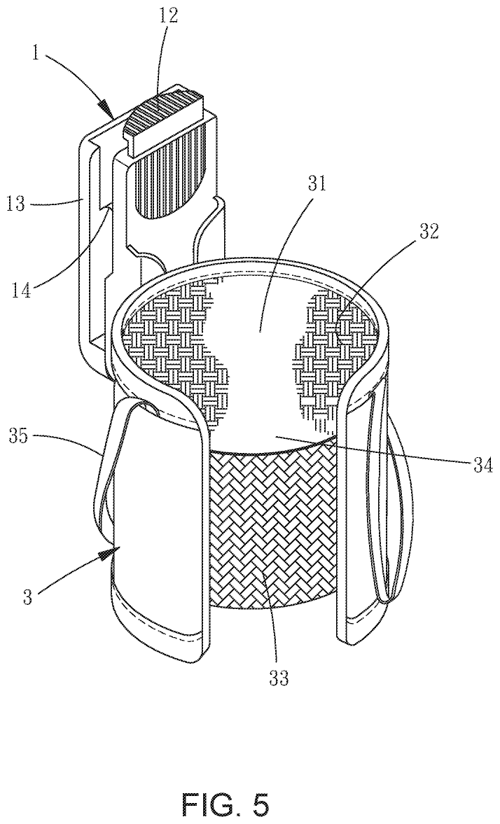

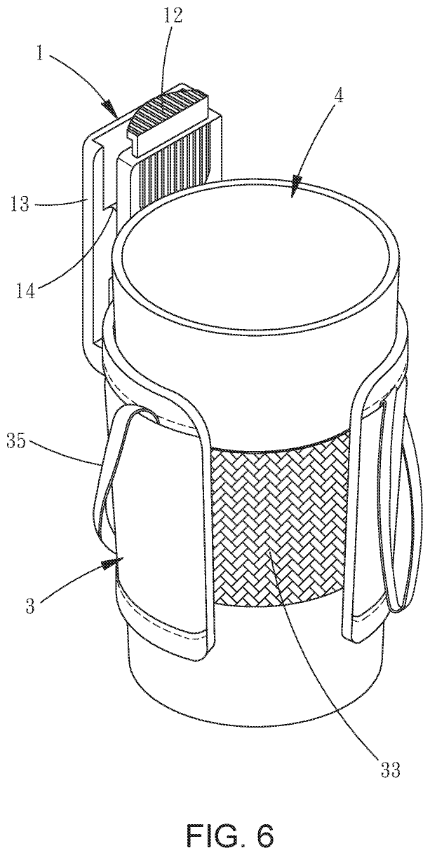

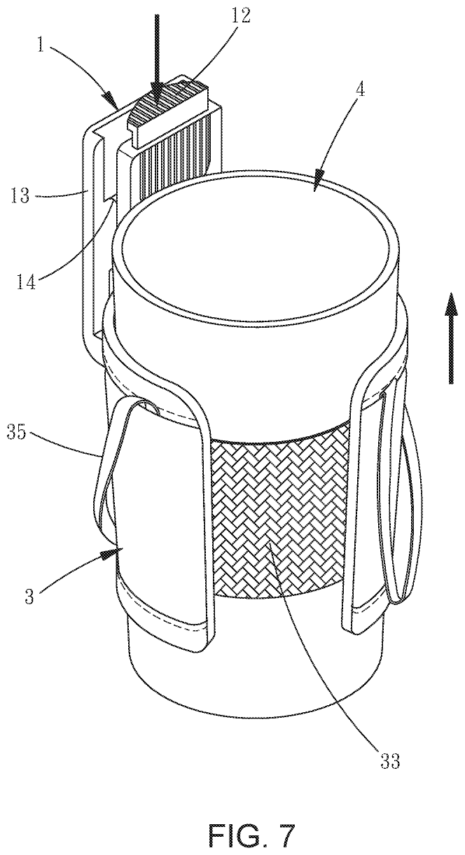

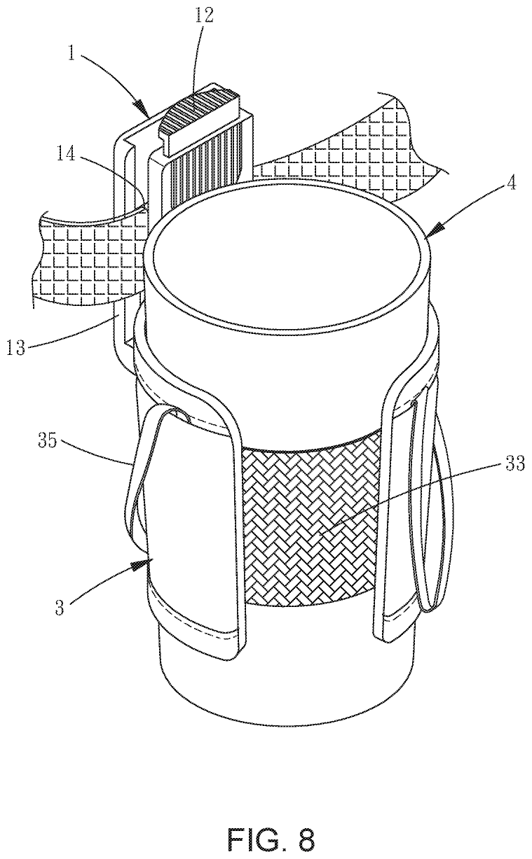

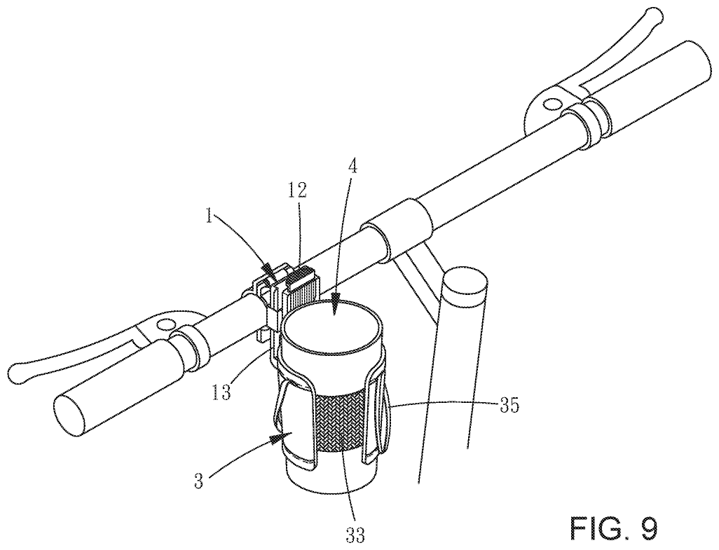

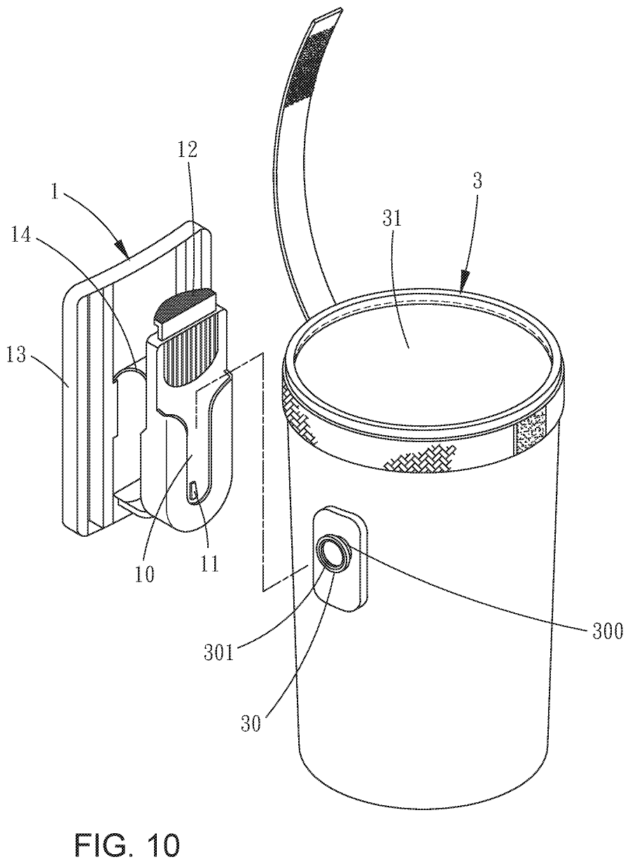

As shown in FIGS. 4 to 10, The second example of the present invention mainly consists of a fastener 1, a cup holder 3, and a water cup 4. The fastener 1 features on its front a slideway 10 and a locking component 11, on which a button 12 controls the fastening or ejection of the locking component 11. On the back of the fastener 1 are a fastening clip 13 and a u-shaped spring metal plate 14. The cup holder 3, combined with the fastener 1, features a protruding ring 30 on one side with a neck portion 300 and a locking slot 301, as well as a placement space at the center, whose inner side comes with an anti-slip covering 32. On the opposite side of the protruding ring 30 on the cup holder 3 is an elastic band 33 and a U-shape opening 34. Each side of the cup holder 3 has a strap 35 on the upper part; the elastic band 33 also functions as a Velcro fastener whose width can be adjusted. The cup holder 3 can also be set up as shown in FIG. 10 to accommodate the water cup 4. The water cup 4 is held in place by the cup holder 3.

In using, insert the fastener 1 into the slot on a waistband or a bicycle, and then place the water cup 4 or a water bottle into the placement space 31 of the cup holder 3. Once the downward force applied to the water cup 4 or the water bottle stops, the elastic band 33 on the cup holder 3 holds the water cup 4 or water bottle in place, and the anti-slip covering 32 inside the cup holder 3 prevents the cup or bottle from moving. The best-case scenario is that the water cup 4 or the water bottle is securely fixed to the cup holder 3. After the water cup 4 or the water bottle is held in place, fit the neck portion 300 of the protruding ring 30 on the cup holder 3 into the slideway 10 on the fastener 1 and slide it to the bottom, where the locking slot 301 of the protruding ring 30 receives the locking component 11, completing the combination of the cup holder 3 and the fastener so that the water cup 4 or the water bottle can be carried around or held in place easily.

The invention has the following advantages as can be seen from the foresaid description.

1. The present invention enables the easy and handy fastening of the water cups 2 and 4.

2. The present invention makes it easier to carry the water cups 2 and 4, as a runner does not have to hold them in his or her hand during the run, resulting in decreased usage of paper cups and making sports more environmentally-friendly.

While the preferred embodiment of the invention has been described above, it will be recognized and understood that various modifications may be made therein and the appended claims are intended to cover all such modifications that may fall within the spirit and scope of the invention.

What is claimed is:

1. A multifunctional water cup sleeve mainly comprising:
a fastener, which features on its front provided with a slideway and a locking component, above which is a button that controls the fastening or ejection of the said locking component, on the back of said fastener provided with a fastening clip and a u-shaped spring metal plate; and
a water cup, which is attached to said fastener and has a protruding ring for fixation on one side.

2. A multifunctional water cup sleeve mainly comprising:
a fastener, which features on its front provided with a slideway and a locking component, above which is a button that controls the fastening or ejection of the said locking component, on the back of said fastener provided with a fastening clip and a u-shaped spring metal plate;
a cup holder, which is attached to said fastener. said cup holder has a placement space at the center, a protruding ring on one side, and an elastic band on the other side; and
a water cup, which is placed in said cup holder.

3. The multifunctional water cup sleeve according to claim 2, said elastic band can also be installed on the outer front of the cup holder.
